(19) United States
(12) Patent Application Publication
(10) Pub. No.: US 2013/0229605 A1
(43) Pub. Date: Sep. 5, 2013

(54) LIQUID CRYSTAL DISPLAY AND OPTICAL COMPENSATION FILM THEREFOR

(71) Applicants: Hee Wook DO, Cheonan-si (KR); Min Oh CHOI, Cheonan-si (KR); Sang-Gu LEE, Seoul (KR); Teck Soo KIM, Seongnam-si (KR); Duck Jong SUH, Seoul (KR); Min Hwa LEE, Asan-si (KR); Hyoung Joo LEE, Gongju-si (KR)

(72) Inventors: Hee Wook DO, Cheonan-si (KR); Min Oh CHOI, Cheonan-si (KR); Sang-Gu LEE, Seoul (KR); Teck Soo KIM, Seongnam-si (KR); Duck Jong SUH, Seoul (KR); Min Hwa LEE, Asan-si (KR); Hyoung Joo LEE, Gongju-si (KR)

(73) Assignee: Samsung Display Co., Ltd., Yongin-City (KR)

(21) Appl. No.: 13/540,397

(22) Filed: Jul. 2, 2012

(30) Foreign Application Priority Data
Mar. 5, 2012 (KR) 10-2012-0022388

(51) Int. Cl. G02F 1/1335; G02B 5/30

(52) U.S. Cl. 349/119; 359/483.01; 349/194; 349/96

(57) ABSTRACT

A compensation film for a liquid crystal display having a characteristic that R0 is about 40 nm-60 nm, Rth is about 140 nm-170 nm, β is about 15°-19°, and the supporting film of the compensation film has a positive dispersion characteristic with respect to the wavelength.

### CROSS-REFERENCE TO RELATED APPLICATION

This application claims priority from and the benefit of Korean Patent Application No. 10-2012-0022388, filed on Mar. 5, 2012, which is hereby incorporated by reference for all purposes as if fully set forth herein.

### BACKGROUND

1. Field

Exemplary embodiments of the present invention relate to an optical compensation film and a liquid crystal display including the same.

2. Discussion of the Background

Currently, a liquid crystal display (LCD) of a TN (twisted nematic) type is used as a monitor. In the TN LCD, the nematic liquid crystal material is horizontally aligned between two substrates while having a slight pre-tilt angle, and an azimuth angle of the liquid crystal molecules is twisted from one substrate to the other substrate by about 90 degrees. By applying an electric field in a vertical direction to the liquid crystal layer of the TN LCD, a director of the liquid crystal is controlled such that optical transmittance is controlled, thereby displaying images.

In the TN method, as opposed to a VA (vertical alignment) method or an IPS (in-plane switching) method, an average direction of the liquid crystal director may be toward a lower side, and in this case, deterioration of display quality may be generated when viewing the display device at vertical viewing angles. However, the display quality in the right and left directions is excellent.

To compensate for the deterioration of display quality at the vertical viewing angles of the TN LCD, a wide viewing angle (WV) film is used.

However, as a result of a limitation of a characteristic of the wide viewing angle film, the liquid crystal layer capable of compensating the viewing angle has a limited characteristic range. Accordingly, the display quality improvement of the transmittance of the liquid crystal display may be limited.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a compensation film having improved transmittance of a liquid crystal display.

Exemplary embodiments of the present invention also provide a liquid crystal display having excellent transmittance and an excellent viewing angle in all directions.

Additional features of the invention will be set forth in the description which follows, and in part will be apparent from the description, or may be learned by practice of the invention.

An exemplary embodiment of the invention discloses a compensation film for a liquid crystal display including a phase difference induction layer and a supporting layer supporting the phase difference induction layer. The compensation film has an in-plane phase difference R0 of about 40 nm-60 nm, a thickness phase difference Rth of about 140 nm-170 nm, and an average inclination angle β of about 15°-19°.

An exemplary embodiment of the present invention also discloses a liquid crystal display including: a first insulation substrate; a second insulation substrate facing the first insulation substrate; a first electrode disposed on at least one of the first insulation substrate and the second insulation substrate; a second electrode disposed on at least one of the first insulation substrate and the second insulation substrate; a liquid crystal layer disposed between the first insulation substrate and the second insulation substrate; and a first compensation film and a second compensation film respectively disposed outside the first insulation substrate and the second insulation substrate. The first compensation film and the second compensation film have an in-plane phase difference R0 of about 40 nm-60 nm, a thickness phase difference Rth of about 140 nm-170 nm, and an average inclination angle β of about 15°-19°.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic cross-sectional view of a liquid crystal display including a compensation film according to an exemplary embodiment of the present invention.

FIG. 2 is a perspective view of a compensation film according to the exemplary embodiment of the present invention.

FIG. 3 is a view showing experimental data for a viewing angle at up/down/left/right directions when applying compensation films of various characteristics to a high transmittance liquid crystal display.

FIG. 4 is a graph showing a wavelength dispersion characteristic of a supporting film of a compensation film according to the exemplary embodiment of the present invention and a conventional supporting film.

FIG. 5 is a view showing a change of a polarization state in a Poincare sphere color coordinate when red, green, and blue polarized light passes through a supporting film of a compensation film according to the exemplary embodiment of the present invention.

FIG. 6 is a view showing a change of a polarization state in a Poincare sphere color coordinate when red, green, and blue polarized light passes through a conventional supporting film.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

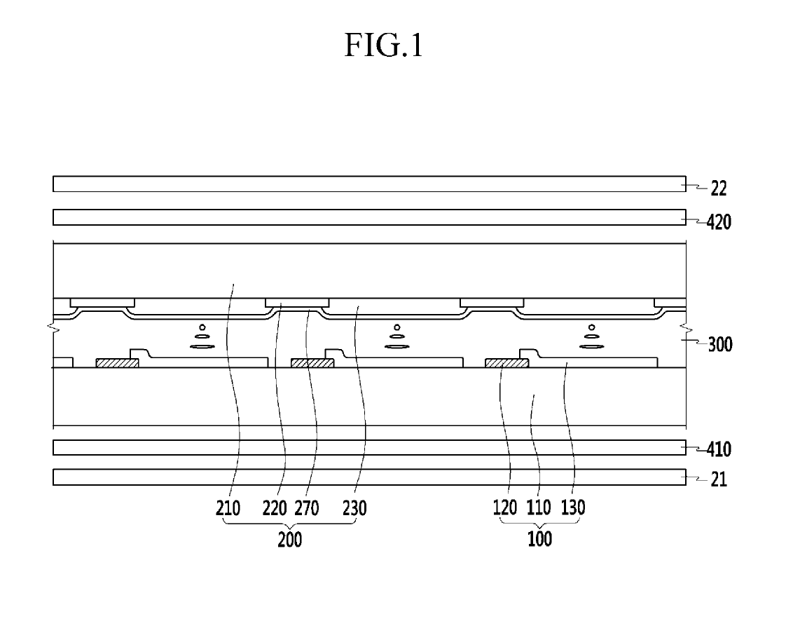

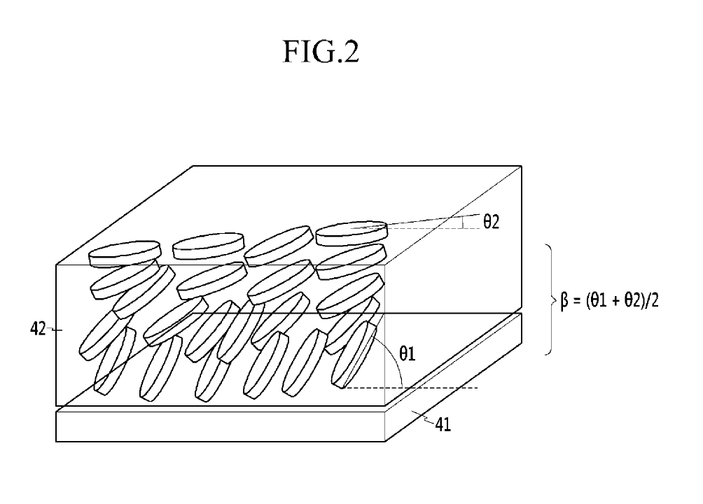

A compensation film and a liquid crystal display including the same according to an exemplary embodiment of the present invention will be described with reference to FIG. 1 and FIG. 2.

FIG. 1 is a schematic cross-sectional view of a liquid crystal display including a compensation film according to an exemplary embodiment of the present invention, and FIG. 2 is a perspective view of a compensation film according to an exemplary embodiment of the present invention.

A liquid crystal display as a TN (twisted nematic) liquid crystal display including a nematic liquid crystal material shown in FIG. 1 includes a lower panel 100, an upper panel 200 facing the lower panel 100, a liquid crystal layer 300 interposed between the lower panel 100 and the upper panel 200, a lower compensation film 410 and an upper compensation film 420 respectively disposed outside the lower panel 100 and the upper panel 200, and a lower polarization film 21 and an upper polarization film 22 positioned “outside” the lower compensation film 410 and the upper compensation film 420, which means that the lower and upper polarization films 21, 22 are each respectively disposed on a side of the lower and upper compensation films 410, 420 which is opposite the side facing the liquid crystal layer 300. Both lower and upper compensation films 410, 420 are not required in the present invention, and the relative positions of compensation film/polarization film may be swapped.

The lower panel 100 includes, for example, an insulation substrate 110, a thin film transistor 120 disposed on the insulation substrate 110, and a pixel electrode 130 connected to the thin film transistor 120. The lower panel 100 also includes signal lines (not shown), such as gate lines and data lines, and an alignment layer (not shown) formed on the thin film transistor 120 and the pixel electrode 130.

The upper panel 100 includes, for example, an insulation substrate 210, a black matrix 220, and a color filter 230 disposed on a lower surface of the insulation substrate 210, and a common electrode 270 formed on the black matrix 220 and the color filter 230. An alignment layer (not shown) is formed on the common electrode 270.

The liquid crystal layer 300 is formed between the lower panel 100 and the upper panel 200. In the liquid crystal layer 300, the liquid crystal is aligned with a twisted nematic mode and has a retardation Δnd of 420 nm-470 nm. For example, if the liquid crystal has a refractive anisotropy Δn of 0.141 and the thickness of the liquid crystal layer 300 is 3.2 μm, the retardation of the liquid crystal layer 300 becomes about 452 nm. If the liquid crystal layer 300 has a retardation Δnd of 420 nm-470 nm, high light transmittance may be obtained as compared with a conventional liquid crystal display using a liquid crystal layer having retardation of about 410 nm.

Table 1 below shows changes in optical characteristics, such as transmittance and luminance, when only retardation of the liquid crystal layer is changed in the liquid crystal display of the same structure (in cases of 410 nm and 452 nm). As shown in Table 1, the case of a liquid crystal layer having a retardation of 452 nm has greater transmittance and luminance values than the case of a liquid crystal layer having a retardation of 410 nm.

TABLE 1

| | | | Case 1 | Case 2 |
|---|---|---|---|---|
| Optical | Actually measured Δnd | | 410 nm | 452 nm |
| characteristic | Trans- | 9 positions | 4.82 | 5.01 (3.84% |
| | mittance | | | improvement) |
| | | Center | 4.77 | 4.95 (3.67% |
| | | | | improvement) |
| | Luminance | 13 positions | 220.7 | 227.4 (3.04% |
| | | | | improvement) |
| | | Center | 230.8 | 246.8 (6.91% |
| | | | | improvement) |

| | | |
|---|---|---|
| Response speed (Tr/Tf) | 5.4 ms | 5.0 ms (1.6/3.4) |
| | (1.7/3.7) | |
| Cr | 971 | 950 |

The compensation films 410 and 420 include a supporting layer 41 and a phase difference induction layer 42. The supporting layer 41 may be made of a TAC (triacetyl cellulose) film, and has a positive wavelength dispersion characteristic. The phase difference induction layer 42 may be formed by including a discotic liquid crystal that is hybrid-aligned. As shown in FIG. 2, the hybrid alignment means that the angles θ1 and θ2 at which the disc-type discotic liquid crystal is inclined with respect to the surface of the supporting layer 41 decreases as distance from the supporting layer 41 increases. That is, the discotic liquid crystal is inclined with a further spread shape the further away the discotic liquid crystal is from the supporting layer 41. An average of the inclination angle β ((θ1+θ2)/2) of the discotic liquid crystal forming the phase difference induction layer 42 is 15°-19°. An in-plane phase difference R0 of the compensation film is 40 nm-60 nm, and a thickness phase difference Rth is 140 nm-170 nm.

The compensation films 410 and 420 may be manufactured by coating a discotic liquid crystal material on a TAC film and curing the coated discotic liquid crystal layer with an appropriate condition.

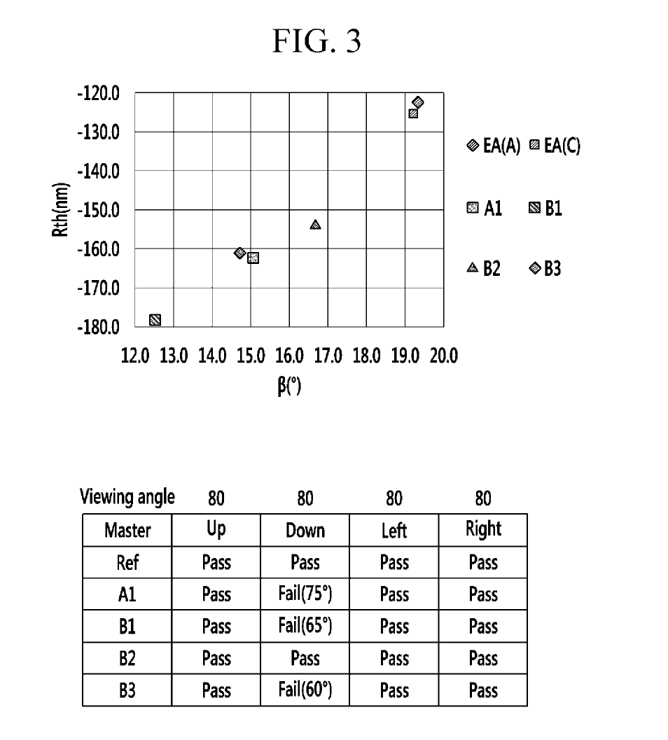

FIG. 3 is a view showing experimental data for a viewing angle at up/down/left/right directions when applying compensation films of various characteristics to a high transmittance liquid crystal display. In the present experimental example, the liquid crystal display includes a liquid crystal layer having a retardation (Δnd) of 452 nm.

With reference to FIG. 3, among the several compensation films, when the compensation film (in the case B2 of FIG. 3) having an in-plane phase difference R0 of 50 nm, a thickness phase difference Rth of 155 nm, and an average inclination angle β of 17° is applied to the liquid crystal display including the liquid crystal layer 300 having a retardation of 452 nm, a viewing angle of more than 80 degrees may be obtained in up/down/left/right directions.

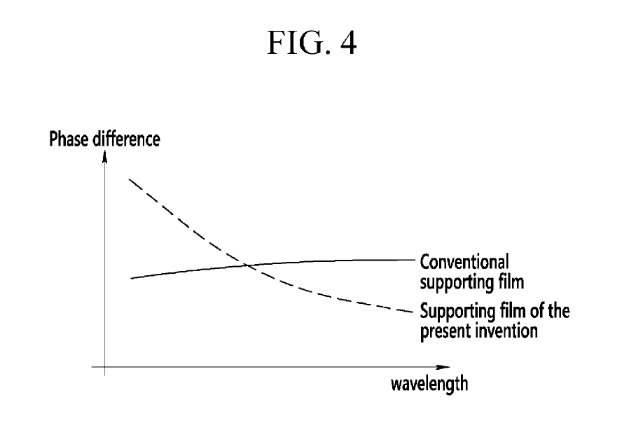

The supporting layer 41 of the compensation films 410 and 420 has a positive wavelength dispersion characteristic. By adding an additive to the TAC (triacetyl cellulose), a supporting layer 41 having a positive wavelength dispersion characteristic may be formed. A is supporting layer 41 having a positive wavelength dispersion characteristic produces the effect described with reference to FIG. 4 to FIG. 6.

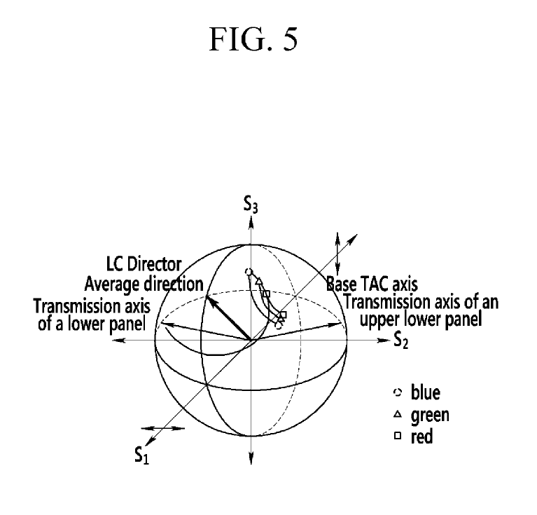

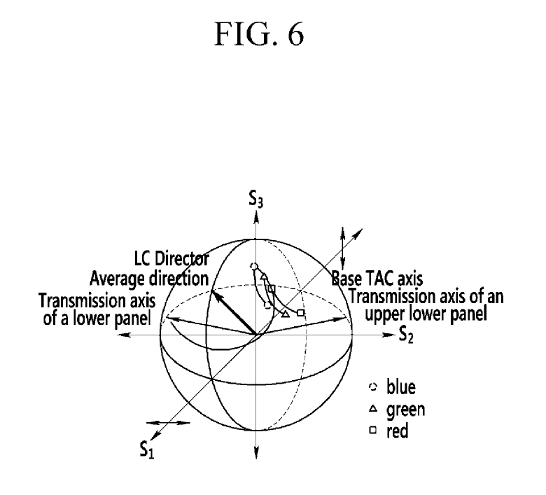

FIG. 4 is a graph showing a wavelength dispersion characteristic of a supporting film of a compensation film according to an exemplary embodiment of the present invention and a conventional supporting film, FIG. 5 is a view showing a change of a polarization state in a Poincare sphere color coordinate when red, green, and blue polarized light passes through a supporting film of a compensation film according to an exemplary embodiment of the present invention, and FIG. 6 is a view showing a change of a polarization state in a Poincare sphere color coordinate when red, green, and blue polarized light passes through a conventional supporting film.

Having a positive wavelength dispersion characteristic for the supporting layer 41 means generating a larger phase difference as the wavelength of the passing light decreases, as shown in FIG. 4. As described above, if the supporting layer 41 has a positive wavelength dispersion characteristic, as shown in FIG. 5, the blue light has a larger phase difference than the green light or the red light, and the green light has a larger phase difference than the red light. Accordingly, the red light, the green light, and the blue light that are spread on a Poincare sphere color coordinate are gathered into positions close to each other after passing through the supporting layer 41. As described above, if the red light, the green light, and the blue light are gathered on the Poincare sphere color coordinate into positions close to each other, a difference degree for the light amount passing through the polarization film 22 may be reduced. In contrast, if the supporting layer 41 has a negative wavelength dispersion characteristic, as shown in FIG. 6, the blue light has a smaller phase difference than the green light or the red light, and the green light has a smaller phase difference than the red light. Accordingly, the red light, the green light, and the blue light that are spread on the Poincare sphere color coordinate are scattered far away from each other after passing through the supporting layer 41. As described above, if the red light, the green light, and the blue light are far away from each other on the Poincare sphere color coordinate, the difference degree for the light amount passing through the polarization film 22 may be increased, thereby generating a yellowish hue.

Each polarization film 21 and 22 may include a polarization layer and passivation layers positioned on opposite sides. The polarization films 21 and 22 may be made of a single film. Two polarization films 21 and 22 may be disposed such that the absorption axis thereof is crossed, and the absorption axes respectively form an angle of 0.5°-1.5° with the rubbing direction of the discotic liquid crystal of the compensation film 410 and 420 adjacent thereto. That is, the absorption axis of the lower polarization film 21 forms an angle of 0.5°-1.5° with the direction in which the discotic liquid crystals of the phase difference induction layer 42 of the lower compensation film 410 are rubbed and inclined, and the absorption axis of the upper polarization film 22 forms an angle of 0.5°-1.5° with the direction in which the discotic liquid crystals of the phase difference induction layer 42 of the upper compensation film 420 are rubbed and inclined.

As described above, when using a compensation film having an R0 of 40 nm-60 nm, Rth of 140 nm-170 nm, and β of 15°-19°, viewing angle deterioration is not generated even though a high transmittance liquid crystal layer is applied to the liquid crystal display. Also, by providing a normal dispersion characteristic for the wavelength through the supporting film of the compensation film, the yellowish hue generated in the side of the liquid crystal display may be reduced.

It will be apparent to those skilled in the art that various modifications and is variations can be made in the present invention without departing from the spirit or scope of the invention. Thus, it is intended that the present invention cover the modifications and variations of this invention provided they come within the scope of the appended claims and their equivalents.

What is claimed is:

1. A compensation film for a liquid crystal display, comprising:
a phase difference induction layer; and
a supporting layer supporting the phase difference induction layer,
wherein the compensation film has an in-plane phase difference R0 of 40 nm-60 nm, a thickness phase difference Rth of 140 nm-170 nm, and an average inclination angle β of 15°-19°.

2. The compensation film of claim 1, wherein
the phase difference induction layer comprises a discotic liquid crystal.

3. The compensation film of claim 2, wherein
the supporting layer has a positive wavelength dispersion characteristic.

4. A liquid crystal display comprising:
a first substrate;
a second substrate facing the first substrate;
a first electrode disposed on at least one of the first substrate and the second substrate;
a second electrode disposed on at least one of the first substrate and the second substrate;
a liquid crystal layer disposed between the first substrate and the second substrate; and
a first compensation film and a second compensation film respectively disposed outside the first substrate and the second substrate,
wherein the first compensation film and the second compensation film have an in-plane phase difference R0 of 40 nm-60 nm, a thickness phase difference Rth of 140 nm-170 nm, and an average inclination angle β of 15°-19°.

5. The liquid crystal display of claim 4, wherein the first compensation film and the second compensation film each comprise a supporting layer comprising a positive wavelength dispersion characteristic.

6. The liquid crystal display of claim 5, wherein
the first compensation film and the second compensation film each comprise a discotic liquid crystal layer.

7. The liquid crystal display of claim 6, wherein
the liquid crystal layer comprises a twisted nematic liquid crystal and retardation And thereof is 420 nm-470 nm.

8. The liquid crystal display of claim 7, wherein
the thickness of the liquid crystal layer is 3.2 μm.

9. The liquid crystal display of claim 7, further comprising
a first polarization film disposed outside the first compensation film and a second polarization film disposed outside the second compensation film, wherein an absorption axis of the first polarization film forms an angle of about 0.5°-1.5° with a rubbing direction of the discotic liquid crystal of the first compensation film, and an absorption axis of the second polarization film forms an angle of about 0.5°-1.5° with a rubbing direction of the discotic liquid crystal of the second compensation film.

10. The compensation film of claim 2, wherein the discotic liquid crystal is hybrid-aligned.

11. The liquid crystal display of claim 6, wherein the discotic liquid crystal layer is hybrid-aligned.
